(19) United States
(12) Patent Application Publication
(10) Pub. No.: US 2009/0316852 A1
(43) Pub. Date: Dec. 24, 2009

(54) METHOD FOR SUPPRESSING DEPOSIT OF RADIONUCLIDE ONTO STRUCTURE MEMBER COMPOSING NUCLEAR POWER PLANT AND FERRITE FILM FORMATION APPARATUS

(76) Inventors: Hideyuki Hosokawa, Hitachinaka (JP); Makoto Nagase, Mito (JP); Satoshi Morisawa, Hitachi (JP); Motoaki Sakashita, Hitachi (JP); Katsuo Yokota, Hitachi (JP)

Correspondence Address: MATTINGLY & MALUR, P.C., 1800 DIAGONAL ROAD, SUITE 370, ALEXANDRIA, VA, 22314, US

(21) Appl. No.: 12/134,277

(22) Filed: Jun. 6, 2008

(30) Foreign Application Priority Data
Jun. 8, 2007 (JP) 2007-152989

(51) Int. Cl. G21C 9/00

(52) U.S. Cl. 376/306; 376/305

(57) ABSTRACT

A method for suppressing deposit of radionuclide onto structure member composing a nuclear power plant, comprising the steps of:
bringing film formation liquid including iron (II) ions and either of zinc (II) ions and nickel (II) ions into contact with a surface of the structure member; and
forming either of a ferrite film including the zinc and a ferrite film including the nickel on the surface of the structure member.

### CLAIM OF PRIORITY

The present application claims priority from Japanese patent application serial no. 2007-152989, filed on Jun. 8, 2007, the content of which is hereby incorporated by reference into this application.

### BACKGROUND OF THE INVENTION

The present invention relates to a method for suppressing deposit of radionuclide onto structure member composing a nuclear power plant and a ferrite film formation apparatus, and more particularly, to a method for suppressing deposit of radionuclide onto structure member composing a nuclear power plant and a ferrite film formation apparatus preferably applied to a boiling water reactor nuclear power plant.

A boiling water reactor nuclear power plant (hereinafter referred to as BWR plant), for example, has a nuclear reactor, which has a core in a reactor pressure vessel (hereinafter referred to as RPV). Cooling water is supplied by a recirculation pump (or an internal pump) to the core, and then heated by heat generated due to nuclear fission of nuclear fuel materials in fuel assemblies loaded in the core. Part of the cooling water becomes steam. The steam is introduced from the nuclear reactor to a turbine. When the turbine is turned, the steam is expelled from the turbine and condensed in a condenser, producing water. The water is supplied to the nuclear reactor as feed water. To suppress generation of radioactive corrosion products in the nuclear reactor, a demineralizer disposed in a feed water pipe mainly removes metal impurities from the feed water.

Corrosion products, from which radioactive corrosion products are produced, are also generated from wetted surface of the RPV, recirculation pipes, and so on, so structure members composing the main primary system are made of stainless steel, nickel-based alloy, and other materials that are less likely to corrode. The RPV, which is made of low-alloy steel, internally has a weld overlay of stainless steel to prevent the low-alloy steel from being brought in direct contact with reactor water, which is cooling water present in the RPV of the nuclear reactor. In addition, part of the reactor water is purified by a demineralizer in a reactor water cleanup system, actively removing metal impurities that are slightly present in the reactor water.

In spite of countermeasures against corrosion as described above, it is unavoidable that an extremely small amount of impurities is present in the reactor water. Accordingly, some metal impurities are deposited on the surfaces of fuel rods included in the fuel assemblies as metal oxide. The metal impurities (metal elements, for example) deposited on the surfaces of the fuel rods undergo nuclear reaction due to radiation of neutrons emitted from the nuclear fuel in the fuel rods, producing cobalt 60, cobalt 58, chromium 51, manganese 54, and other radionuclides. Most of these radionuclides are left deposited on the surfaces of the fuel rods in the form of oxide. However, some radionuclides are dissolved as ions into the reactor water according to the solubility of the included oxide, and other radionuclides are released again into the reactor water as insoluble solid called crud. Radioactive materials in the reactor water are removed by the reactor water cleanup system. However, radioactive materials that have not been removed circulate in, for example, a recirculation system together with the reactor water. During this recirculation, the radioactive materials are accumulated on the surface (hereinafter referred to as wetted surface), with which the reactor water is brought into contact. As a result, radiation is emitted from the reactor component surfaces, causing workers in charge of periodic inspection to be exposed to the radiation. Exposure dose is managed for each worker so that it does not exceed a predetermined value. Recently, predetermined values for the exposure dose have been lowered, causing a need to lower the exposure dose for the each worker as much as possible, in an economical manner.

Many methods for reducing deposition of radionuclides onto inner surface of pipes (structure members) and many method for reducing the concentrations of radionuclides in the reactor water are considered. For example, in a method proposed in Japanese Patent Laid-open No. Sho 58 (1983)-79196, metal ions such as zinc ions are supplied into the reactor water to closely form an oxide film, including zinc, with close and low porosity on the inner surface (wetted surface) of the recirculation pipe, with which the reactor water is brought into contact, so that inclusion of radionuclides such as cobalt 60 and cobalt 58 into the oxide films is suppressed.

Japanese Patent Laid-open No. 2006-38483 (US2006/0067455A) proposes another method for suppressing deposit of radionuclide onto structure member composing a nuclear power plant. This method forms a magnetite film as a ferrite film onto wetted surface, on which chemical decontamination has been performed, of the structure members, thereby suppressing deposition of radionuclides onto the wetted surface of the structure members after an operation of the nuclear power plant. In this method, a treatment solution that includes a formic solution including iron (II) ions, hydrogen peroxide, and hydrazine is heated in a range from an ordinary temperature to 100° C., and the heated treatment solution is brought into contact with the wetted surface of the structure members to form a ferrite film on the surface.

### SUMMARY OF THE INVENTION

However, when metal ions such as zinc ions are injected into the reactor water in order to suppress inclusion of the radioactive ions such as cobalt 60 into the oxide film formed on the structure members as in the method described in Japanese Patent Laid-open No. Sho 58 (1983)-79196, it is necessary to continue the supply of the zinc ions during operation. Another problem is that, to prevent radioactivation of zinc itself, zinc for which isotopic separation has been carried out must be used.

The method disclosed in Japanese Patent Laid-open No. 2006-38483, in which a ferrite film is formed, does not raise the above problems involved in Japanese Patent Laid-open No. Sho 58 (1983)-79196. Due to the formed ferrite film, radionuclide deposition on the structure members composing the nuclear power plant can be suppressed. In this method, the amount of radionuclide deposition on the reactor component of the nuclear power plant can be significantly reduced, as compared with other methods, and thereby the dose rate of the recirculation pipe can be sufficiently reduced. However, due to diffusion of the radioactive cobalt ions and the like, their inclusion into a magnetite film, which is a ferrite film, cannot be completely eliminated (see sample E in FIG. 4 in Japanese Patent Laid-open No. 2006-38483).

An object of the present invention is to provide a method for suppressing deposit of radionuclide onto structure member composing a nuclear power plant and a ferrite film formation apparatus that can further suppress radionuclide deposition.

A feature of the present invention for attaining the above object is that a film formation solution including iron (II) ions and either of zinc (II) ions and nickel (II) ions is brought into contact with surface of a structure member composing a nuclear power plant so as to form, on the surface, either of a first ferrite film including zinc and a second ferrite film including nickel.

Either of the first and second ferrite film has higher stability than a magnetite film that does not include zinc or nickel, so suppression of radionuclide deposition onto the surfaces of the structure members is enhanced.

There is no restriction on a first chemical including iron (II) ions, if it is a chemical compound including iron (II) ions or its aqueous solution. An example of the first chemical including iron (II) ions is an aqueous solution of salt resulting from iron and an organic acid or inorganic acid. In particular, the organic acid and carbonic acid are preferably used to prepare the first chemical because, after being used, they can be decomposed into carbon dioxide and water. Examples of organic acid include formic acid, malonic acid, diglycolic acid, and oxalic acid. When the amount of formed ferrite film and uniformity of the ferrite film are considered, an aqueous solution of iron (II) formate is preferably used as the first chemical. Furthermore, an aqueous solution including iron (II) ions that elutes from iron electrode by electrolysis in which metal iron is used as an electrode, may be used as the first chemical.

There is no restriction on a second chemical including either of zinc (II) ions and nickel (II) ions, if it is a chemical compound including either of zinc (II) ions and nickel (II) ions or its aqueous solution. An example of the second chemical including at least either of zinc (II) ions and nickel (II) ions is an aqueous solution of salt resulting from zinc or nickel and an organic acid or inorganic acid. In particular, as with the first chemical, the organic acid and carbonic acid are preferably used to prepare the second chemical because they can be decomposed into carbon dioxide and water. Examples of organic acid include formic acid, malonic acid, diglycolic acid, and oxalic acid.

As a third chemical, an oxidizing agent for oxidizing iron (II) ions to iron (III) ions or its aqueous solution can be used. To form ferrite by using a solution including iron (II) ions, part of the iron (II) ions first needs to be oxidized to iron (III) ions. The oxidizing agent is, for example, hydrogen peroxide.

A treatment solution (preferably, aqueous solution) including the first chemical, second chemical, and third chemical is used to form the ferrite film. The pH of the treatment solution is preferably adjusted to a prescribed value. A fourth chemical is a pH adjustment agent or its aqueous solution that adjusts the pH of the treatment solution. The pH of the treatment solution is adjusted to 5.5 to 9.0 by using the pH adjustment agent. Hydrazine and other basic substances can be used as the pH adjustment agent.

According to the present invention, suppression of radionuclide deposition onto the surfaces of structure member composing a nuclear power plant is enhanced.

### BRIEF DESCRIPTION OF THE DRAWINGS

FIG. 1 is a flowchart showing a processing procedure being carried out in a method for suppressing deposit of radionuclide onto structure member composing a nuclear power plant of a first embodiment which is one preferable embodiment of the present invention.

FIG. 2 is an explanatory drawing showing the amounts of Co-60 deposition (relative values) to stainless steel samples the surfaces of which are machined in various ways, in a case where the samples are immersed in water at high temperature during a BWR operation.

FIG. 3 is electron micrographs showing cross sections of samples B and C in FIG. 2, on each of which a film has been formed.

FIG. 4 is a diagrammatic drawing schematically showing the electron micrographs of samples B and C in FIG. 3, on each of which a film has been formed, showing longitudinal cross sections of samples B and C near their surfaces.

FIG. 5 is a structural diagram showing a BWR plant to which a film formation apparatus is connected when the processing procedure shown in FIG. 1 is applied to the BWR plant.

FIG. 6 is a detailed structural diagram showing the film formation apparatus shown in FIG. 5.

FIG. 7 is an explanatory drawing showing a ferrite film including Zn, which is formed on inner surface of recirculation pipe shown in FIG. 5 by using the film formation apparatus shown in FIG. 6.

FIG. 8 is a detailed structural diagram showing a film formation apparatus used in a method for suppressing deposit of radionuclide onto structure member composing a nuclear power plant of a second embodiment which is another embodiment of the present invention.

FIG. 9 is an explanatory drawing showing a state in which an inert gas supply pipe and a bent pipe are connected to plugs that block both ends of a recirculation pipe in the second embodiment.

FIG. 10 is a flowchart showing a processing procedure being carried out in a method for suppressing deposit of radionuclide onto structure member composing a nuclear power plant of a third embodiment which is another embodiment of the present invention.

FIG. 11 is an explanatory drawing showing a state in which a zinc (II) ion injection apparatus is connected to a feed pipe when a step S10 shown in FIG. 10 is executed.

FIG. 12 is an explanatory drawing showing a ferrite film formed on an inner surface of the recirculation pipe when steps S4, S6, and S7 shown in FIG. 10 are executed.

### DETAILED DESCRIPTION OF THE PREFERRED EMBODIMENTS

The inventors made various studies to find a method by which radionuclide deposition onto surface of structure member composing a nuclear power plant can further be suppressed as compared with the ferrite film formation method described in Japanese Patent Laid-open No. 2006-38483. Finally, the inventors made it clear that after a magnetite film is closely formed with low porosity at a temperature at which diffusion rate of dissolved oxygen into the base metal is small (at 100° C. or lower for example) and a film including zinc is formed on a magnetite film, inclusion of cobalt, which is a type of radionuclide, can be further suppressed as compared with a magnetite film lacking zinc.

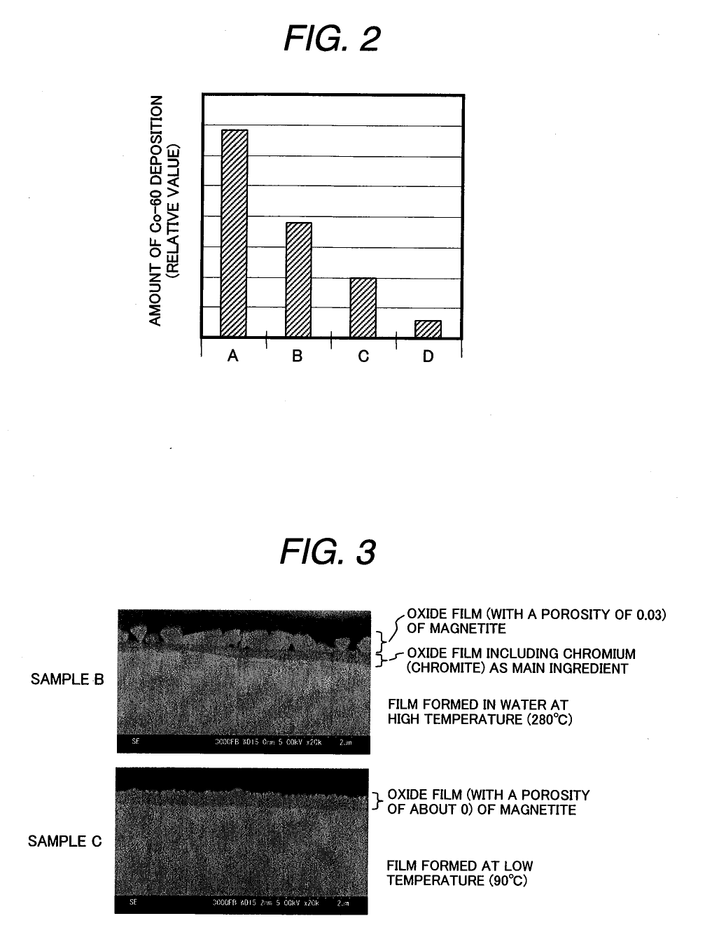

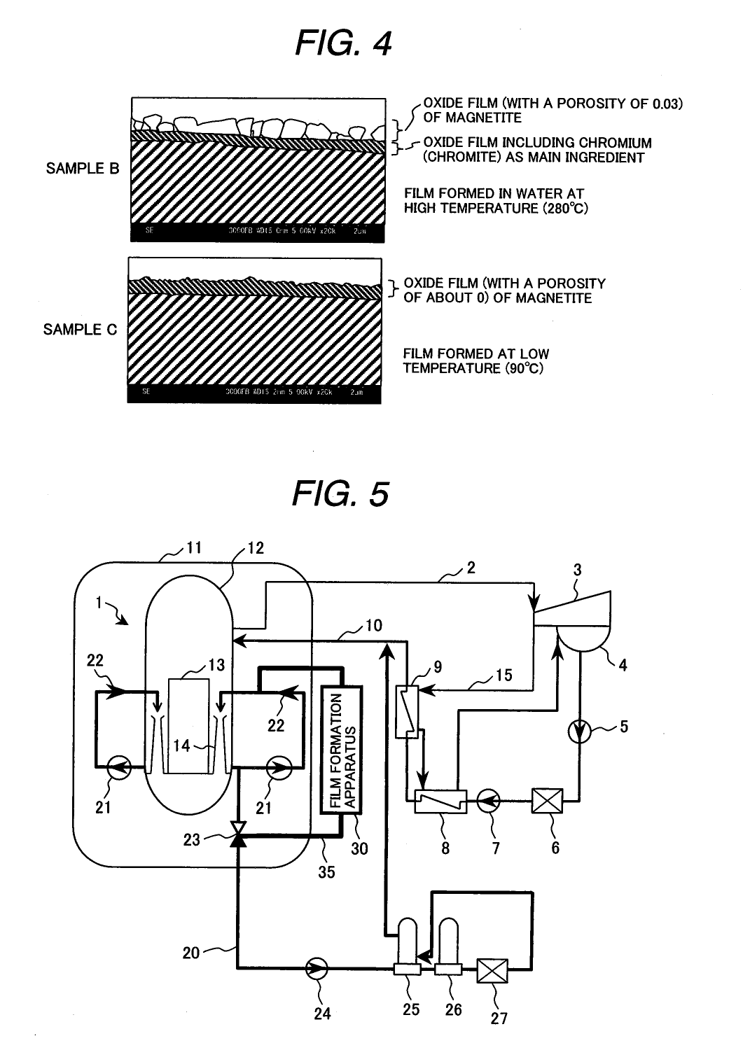

Specifically, the inventors formed either of a magnetite film and ferrite film including zinc on each surface of a stainless steels being structure member composing of the nuclear power plant, immersed the stainless steel having the magnetite film and the stainless steel having the ferrite film including zinc in hot water, which is a condition required to operate the BWR, and checked the amount of Co-60 deposited on each stainless steel. Then, the inventors found that when a magnetite film including zinc is formed on the stainless steel surface, the amount of Co deposition on the stainless steel surface can be significantly reduced as shown in FIG. 2. In FIG. 2, the vertical axis indicates the relative values of the amounts of Co-60 deposition on samples A, B, C, and D. The sample A was obtained by mechanically polishing a stainless steel surface. The sample B was obtained by forming pre-oxidized film on a stainless steel surface on condition of reactor water that temperature is 280° C. and pressure is 8-MPa. The sample C was obtained by forming a magnetite film with a porosity of less than 0.03 on a stainless steel surface at a temperature of 100° C. or lower. The sample D was obtained by forming a magnetite film including zinc on a stainless steel surface. The amount of Co-60 deposition on sample B, on which the pre-oxidized film is formed, is less than the amount of Co-60 deposition on sample A, for which no countermeasures against Co-60 deposition are taken. FIG. 3 is electron micrographs showing the cross sections of samples B and C, on each of which a film is formed, these micrographs being taken before deposition test is carried out. FIG. 4 schematically illustrates the electron micrographs shown in FIG. 3. The states of sample B and C are the same in FIGS. 3 and 4. For sample B on which a film was formed in water at high temperature, the magnetite film formed on the surface has a vacancy with a porosity of 0.03. Sample B allows Co-60 to be included in the oxide film through the porosities, the main component of the oxide film being chromium, which is easily adsorb cobalt. Accordingly much more Co-60 deposits on sample B, as compared with sample C, which lacks porosities. Table 1 shows results of analyzing samples C and D with an energy dispersive X-ray spectroscopy (EDX). Sample C lacks zinc. The total content of Cr, Mn, Fe, and Ni included in sample C is 99.5%. Impurities occupy the remaining 0.5%. For sample D, it is found that zinc is included in the formed magnetite film. The amount of Co-60 deposition on sample D is significantly suppressed due to the formed magnetite film including zinc, as shown in FIG. 2.

TABLE 1

| | Contents of atoms (%) | | | | |
|---|---|---|---|---|---|
| | Cr | Mn | Fe | Ni | Zn |
| Sample C | 14.1 | 0.6 | 76.3 | 8.5 | 0 |
| Sample D | 13.3 | 0.8 | 77.3 | 7.3 | 1.4 |

The inventors strived to find reasons why the magnetite film including zinc significantly suppresses Co-60 deposition. To compare stability at the reactor water temperature between magnetite (Fe₃O₄) and zinc ferrite ZnFe₂O₄), standard Gibbs free energy changes of formation (ΔG°) was first investigated for an exchange reaction of bivalent ions included in the magnetite and zinc ferrite. Then it was found that ΔG° of the zinc ferrite is negative and thus the zinc ferrite is more stable than the magnetite. Specifically, when zinc is supplied to the magnetite film formed at a temperature of 100° C. or lower, with a porosity of less than 0.03, part of iron (II) ions included in the magnetite are replaced with zinc (II) ions as indicated by reaction of formula (1). As a result, the stability of the zinc ferrite film formed on the surface of sample D is further increased. It can be thereby considered that the zinc ferrite film increase further suppresses corrosion of the base material and thus Co-60 deposition is further suppressed as compared with the case in which the magnetite film is used.

Fe₃O₄+Zn²⁺=ZnFe₂O₄+Fe²⁺ (1)

(ΔG°=−9.4 kJ/mol)

(Source of reaction formula (1): M. Haginuma et. al., 1998, JAIF International Conference on Water Chemistry in Nuclear Power Plant, p. 122)

According to the above consideration, it can be thought that when nickel is used instead of zinc, the same effect is also obtained. To compare stability at the reactor water temperature between magnetite and nickel ferrite (NiFe₂O₄), standard Gibbs free energy changes of formation (ΔG°) was first investigated for an exchange reaction of bivalent ions included in the magnetite and nickel ferrite. Then it was found that ΔG° of the nickel ferrite is negative and thus the nickel ferrite is more stable than the magnetite. Specifically, when nickel is supplied to the magnetite film formed at a temperature of 100° C. or lower, with a porosity of less than 0.03, part of iron (II) ions included in the magnetite are replaced with nickel (II) ions as indicated by reaction of formula (2). As a result, the stability of the nickel ferrite film is further increased. It can be thereby considered that the nickel ferrite film further suppresses corrosion of the base material and thus Co-60 deposition is further suppressed as compared with the case in which the magnetite film is used.

Fe₃O₄+Ni²⁺=NiFe₂O₄+Fe²⁺ (2)

(ΔG°=−18.66 kJ/mol)

(Source of formula (2): M. Haginuma et. al., 1998, JAIF International Conference on Water Chemistry in Nuclear Power Plant, p. 122)

The present invention was accomplished according to the above results obtained by the inventors.

The base metals used as the above samples simulate structure member composing of a nuclear power plant. The reactor components of a nuclear power plant are members constituting the nuclear power plant, which are metal members that are brought into contact with reactor water including radioactive substances generated in the nuclear reactor in the nuclear power plant. Exemplary structure members are metal members constituting a primary loop recirculation system or reactor water cleanup system in a BWR plant. However, the structure members are not limited to these metal members. It is also possible to form the zinc ferrite film or nickel ferrite film on surfaces of metal members that are brought into contact with reactor water in a nuclear power plant (PWR plant) having a pressurized water reactor (PWR). These metal members are mainly made of stainless steel.

Embodiments of the present invention will be described below.

### First Embodiment

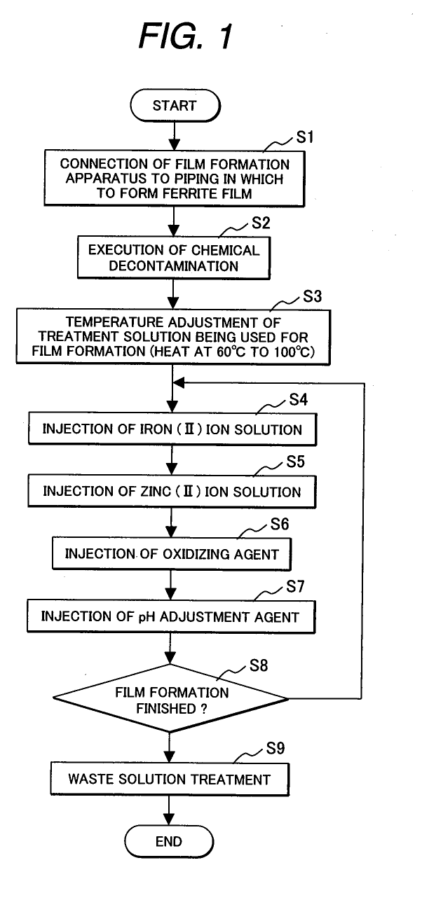

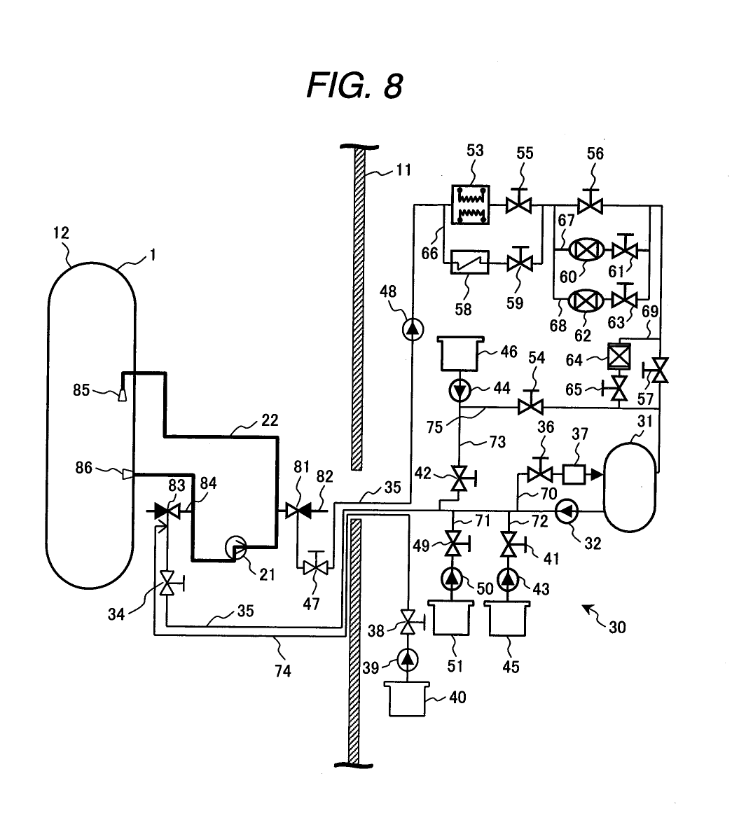

A method for suppressing deposit of radionuclide onto structure member composing a nuclear power plant of a first embodiment which is one preferable embodiment of the present invention will be described below with reference to FIGS. 1, 5 and 6. The first embodiment is an example applied to a BWR power plant (hereinafter referred to as BWR plant). The general structure of the BWR plant will be described below with reference to FIG. 5, and the general structure of a film formation apparatus (a ferrite film formation apparatus) used to form ferrite films on the surfaces of structure members composing the BWR plant will be described below with reference to FIG. 8.

The BWR plant, which is a nuclear power generation plant, is provided with a nuclear reactor 1, a turbine 3, a condenser 4, a recirculation system, a reactor core cleanup system, and a feed water system. The nuclear reactor 1 has a reactor pressure vessel (hereinafter referred to as RPV) 12 including a core 13. A jet pump 14 is mounted in the RPV 12. The nuclear reactor 1 is disposed in a primary containment vessel 11. Many fuel assemblies (not shown) are loaded in the core 13. Each fuel assembly includes a plurality of fuel rods, each of which is loaded with fuel pellets manufactured from nuclear fuel. The recirculation system has recirculation pumps 21 and recirculation pipes 22, one recirculation pump 21 being disposed on one recirculation pipe 22. In the feed water system, a condensing pump 5, a condensed water cleanup apparatus 6, a feed water pump 7, a low-pressure feed water heater 8, and a high-pressure feed water heater 9 are provided on a feed water pipe 10 that interconnects the condenser 4 and RPV 12. In the reactor water cleanup system, a cleanup pump 24, a regenerative heat exchanger 25, a non-regenerative heat exchanger 26, and a reactor water cleanup apparatus 27 are provided on a cleanup system pipe 20 that interconnects the recirculation pipe 22 and feed water pipe 10. The cleanup system pipe 20 is disposed upstream of the recirculation pump 21 and connected to the recirculation pipe 22.

The cooling water (reactor water) in the RPV 12 is pressurized by the recirculation pump 21. The pressurized cooling water passes through the recirculation pipe 22 and is jetted into the jet pump 14. Cooling water around the jet pump 14 is also sucked therein and supplied to the core 13. The cooling water supplied to the core 13 is then heated by heat generated by nuclear fission of the nuclear fuel materials in the fuel rods. Part of the heated cooling water becomes steam. The steam is introduced from the RPV 12 to the turbine 3 through a main steam pipe 2, and turns the turbine 3. A power generator (not shown) connected to the turbine 3 is rotated, generating electric power. Steam exhausted from the turbine 3 is condensed by the condenser 4 and becomes water. This water is then supplied to the RPV 12 through the feed water pipe 10, as feed water. The feed water being introduced through the feed water pipe 10 is pressurized by the condensing pump 5. Impurities in the feed water are removed by the condensed water cleanup apparatus 6. The feed water is further pressurized by the feed water pump 7 and heated by the low-pressure feed water heater 8 and high-pressure feed water heater 9. The steam extracted from the main steam pipe 2 and the turbine 3 by an extraction pipe 15 is supplied to the low-pressure feed water heater 8 and the high-pressure feed water heater 9. A heat source of the feed water flowing in the feed water pipe 10 is the extracted steam.

Part of the cooling water flowing through the recirculation pipe 22 is supplied by the cleanup pump 24 into the cleanup system pipe 20, and is purified in the reactor water cleanup apparatus 27. The purified cooling water is returned trough the cleanup system pipe 20 and feed water pipe 10 to the RPV 12.

After the operation of the BWR plant is stopped, a circulation pipe 35 of the film formation apparatus 30 is connected to the recirculation pipe 22 and cleanup system pipe 20. The film formation apparatus 30 is temporary equipment. When the treatment of the solution used to form the ferrite film was finished, the film formation apparatus 30 is removed from the recirculation pipe 22 and cleanup system pipe 20. The film formation apparatus 30 is used to form a ferrite film on the inner surface of the recirculation pipe 22 and to treat a solution (waste water) that has been used for the film formation. The film formation apparatus 30 is also used for chemical decontamination in the recirculation pipe 22.

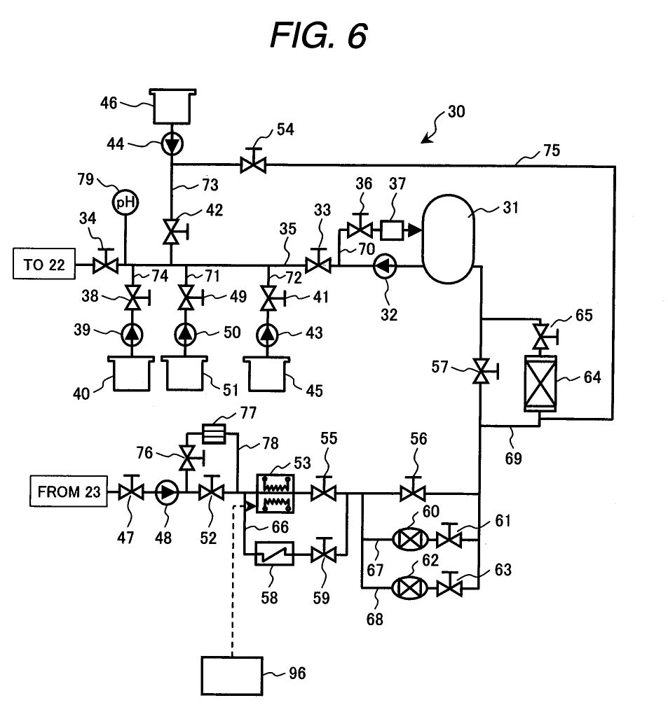

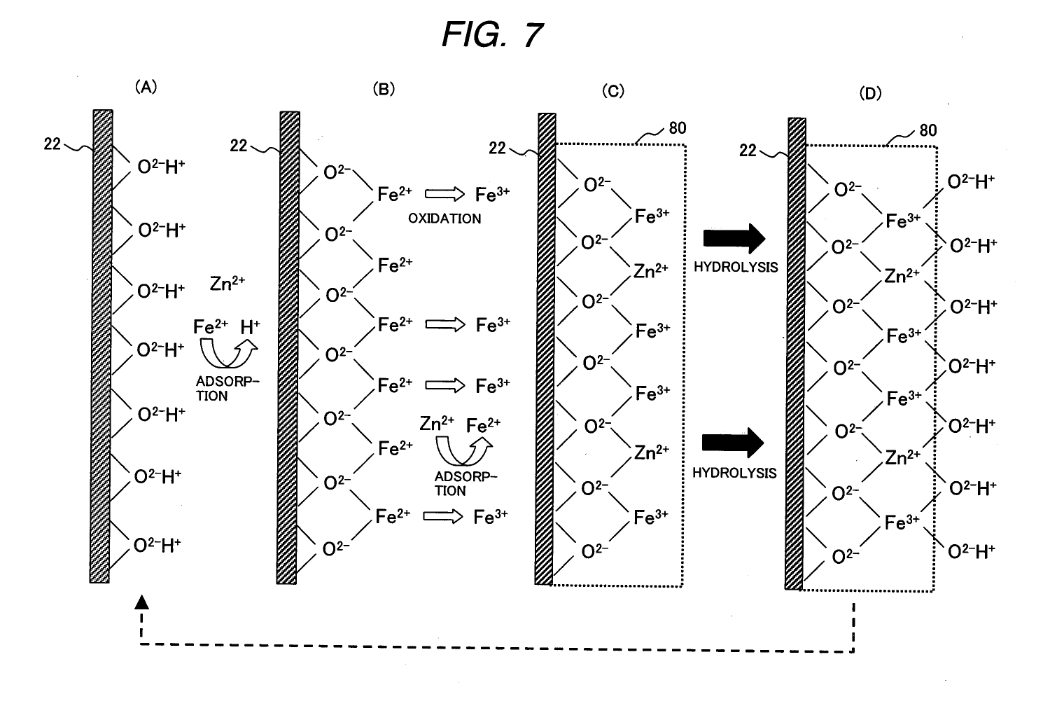

The detailed structure of the film formation apparatus 30 will be described below with reference to FIG. 6. The film formation apparatus 30 has a surge tank 31, the circulation pipe 35, chemical solution tanks 40, 45, 46, and 51, a filter 77, a decomposition apparatus 64, and a cation exchange resin tower 60. An open/close valve 47, a circulation pump 48, a valve 52, a heater 53, valves 55, 56, and 57, the surge tank 31, a circulation pump 32, a valve 33, and an open/close valve 34 are installed on the circulation pipe 35 in that order from its upstream. A valve 76 and a filter 77 are provided on a pipe 78, which bypasses the valve 52 and is connected to the circulation pipe 35 at both ends. A pipe 66, which bypasses the heater 53 and valve 55, is connected to the circulation pipe 35 at both ends. A cooler 58 and a valve 59 are installed on the pipe 66. The cation exchange resin tower 60 and a valve 61 are included on a pipe 67, which bypasses the valve 56 and is connected to the circulation pipe 35 at both ends. A mixed bed resin tower 62 and a valve 63 are provided on a pipe 68, which bypasses the valve 56 and is connected to the circulation pipe 35 at both ends. A pipe 69, to which a valve 65 and the decomposition apparatus 64 are connected, bypasses the valve 57 and is connected to the circulation pipe 35. The decomposition apparatus 64 is internally loaded with activated carbon catalyst produced by spreading, for example, ruthenium on the surface of activated carbon. A pipe 70, on which a valve 36 and an ejector 37 are installed, is connected to the circulation pipe 35 between the valve 33 and circulation pump 32 and further connected to the surge tank 31. The ejector 37 internally has a hopper (not shown) for supplying, into the surge tank 31, permanganic acid to oxidize and dissolve contamination on inner surface of pipes (the recirculation pipe 22, for example) for which chemical decontamination is performed and oxalic acid to reduce and dissolve contamination in the pipes. The pipes for which chemical decontamination is performed are pipes on the inner surfaces of which ferrite films are formed.

An iron (II) ion injection apparatus has the chemical solution tank 45, an injection pump 43, and an injection pipe 72. The chemical solution tank 45 is connected to the circulation pipe 35 through the injection pipe 72 on which the injection pump 43 and a valve 41 are disposed. The chemical solution tank 45 is filled with a first chemical, which includes iron (II) ions prepared by dissolving iron with formic acid. The first chemical includes formic acid. Chemical agent for dissolving iron is not limited to formic acid; organic acid that has counter-anions of iron (II) ions or carbonic acid can be used. A zinc (II) ion injection apparatus has the chemical solution tank 51, an injection pump 50, and an injection pipe 71. The chemical solution tank 51 is connected to the circulation pipe 35 through the injection pipe 71 on which the injection pump 50 and a valve 49 are disposed. The chemical solution tank 51 is filled with a second chemical including zinc (II) ions prepared by dissolving zinc with formic acid. An oxidizing agent injection apparatus has the chemical agent tank 46, an injection pump 44, and an injection pipe 73. The chemical solution tank 46 is connected to the circulation pipe 35 through the injection pipe 73 on which the injection pump 44 and a valve 42 are disposed. The chemical solution tank 46 is filled with hydrogen peroxide, which is an oxidizing agent (third chemical). A pH adjustment agent injection apparatus has the chemical agent tank 40, an injection pump 39, and an injection pipe 74. The chemical solution tank 40 is connected to the circulation pipe 35 through the injection pipe 74 on which the injection pump 39 and a valve 38 are disposed. The chemical solution tank 40 is filled with hydrazine, which is a pH adjustment agent (fourth chemical). A pipe 75, on which a valve 54 is disposed, interconnects the pipe 73 and pipe 69. The surge tank 31 is originally filled with water used for treatment. To remove oxygen included in the solution in the chemical solution tank 45 and surge tank 31, they are each preferably connected to an inert gas injection apparatus (not shown) for bubbling nitrogen, argon, or another inert gas.

A second connection point of the zinc (II) ion injection apparatus to the circulation pipe 35, at which the injection pipe 71 is connected to the circulation pipe 35, is positioned downstream of a first connection point of the iron (II) ion injection apparatus to the circulation pipe 35, at which the injection pipe 72 is connected to the circulation pipe 35, and upstream of a third connection point of the oxidizing agent injection apparatus to the circulation pipe 35, at which the injection pipe 73 is connected to the circulation pipe 35. The third connection point is positioned downstream of the second connection point and upstream of a fourth connection point of the pH adjustment agent injection apparatus to the circulation pipe 35, at which the injection pipe 74 is connected to the circulation pipe 35. That is, the first connection point, second connection point, third connection point, and fourth connection point are positioned in that order from the upstream. The fourth connection point is preferably positioned on the circulation pipe 35 as close to an area of chemical decontamination and ferrite film formation as possible.

The decomposition apparatus 64 decomposes organic acid (formic acid, for example) used as counter anions of iron (II) ions and hydrazine used as the pH adjustment agent. Specifically, as the counter anions of iron (II) ions, organic acid, which can be decomposed into water and carbon dioxide, is used to reduce the amount of waste materials, or carbonic acid, which can be released as a gas, is used to prevent the amount of waster materials from being increased.

The method for suppressing deposit of radionuclide onto structure member composing a nuclear power plant in the present embodiment, which uses the film formation apparatus 30 to form a zinc ferrite film on the inner surface of the recirculation pipe 22, will be described in detail with reference to FIG. 1. The radionuclide deposition suppression method in the present embodiment is carried out within a periodic inspection (including maintenance) of the BWR pant during which its operation is stopping. First, the film formation apparatus 30 is connected to a piping being a target onto surface of which a ferrite film is formed (step S1). The piping being the target on which the ferrite film is formed, for example, the recirculation pipe 22. Specifically, after the operation of the BWR plant is stopped due to its periodic inspection, the circulation pipe 35 is connected to the recirculation pipe 22 and cleanup system pipe 20, as described above. The cleanup system pipe 20 installs a valve 23. The hood of the valve 23 is opened to shut out the cleanup system pipe 20 on the reactor water cleanup apparatus 27 side. An end of the circulation pipe 35 is connected to the flange of the valve 23. The opposite end of the circulation pipe 35 is connected to, for example, a branch pipe (a branch pipe from which a drain pipe, an instrument pipe, and the like are disconnected) that is positioned downstream of the recirculation pump 21 and connected to the recirculation pipe 22. The film formation apparatus 30 is connected to the recirculation pipe 22 in this way. Both ends of the recirculation pipe 22 are plugged as shown in FIG. 8 so that the decontamination liquid and film formation aqueous solution supplied into the recirculation pipe 22 do not enter the RPV 12.

Chemical decontamination is carried out for a target (for example, recirculation pipe 22) on which a ferrite film is formed (step S2). An oxide film (contaminant) including radionuclides is formed on the inner surface, which is brought into contact with the cooling water, of the recirculation pipe 22. An example of step S2 is processing for removing the oxide film including radionuclides from the inner surface of the recirculation pipe 22, on which to form a film, through chemical treatment. A ferrite film is formed on the inner surface of a pertinent pipe to suppress radionuclide deposition to the piping. Chemical decontamination is preferably performed on the inner surface before the ferrite film is formed. It suffices to allow the surface of a metal member on which to form a ferrite film to be exposed before the ferrite film is formed, so mechanical decontamination can also be applied instead of chemical decontamination.

Although the chemical decontamination carried out in step S2 is an already known method (see Japanese Patent Laid-open No. 2000-105295 (U.S. Pat. No. 6,335,475)), it will be briefly described below. First, the circulation pumps 32 and 48 are started with the valves 34, 33, 57, 56, 55, 52, and 47 open and the other valves closed so that the water in the surge tank 31 is circulated into the recirculation pipe 22 where decontamination is performed. The circulating water is heated by the heater 53 up to a temperature of about 90° C. After the temperature was raised to about 90° C., the valve 36 is opened. A necessary amount of potassium permanganate from the hopper connected to the ejector 37 is supplied to the surge tank 31 through the pipe 70 by the water flowing in the pipe 70. The potassium permanganate is dissolved in water in the surge tank 31, producing an oxidation decontamination solution. The circulation pump 32 is driven and the oxidation decontamination solution is supplied to the recirculation pipe 22 through the circulation pipe 35, valve 34, and cleanup system pipe 20. The oxidation decontamination solution dissolves the oxide film and other contaminants formed on the inner surface of the recirculation pipe 22 by oxidizing them.

After the decontamination by the use of the oxidation decontamination solution is finished, permanganate ions remaining in the oxidation decontamination solution are decomposed by oxalic acid supplied from the above hopper to the surge tank 31. After the potassium permanganate has been decomposed, reduction decontamination is conducted by using a reduction decontamination solution. The reduction decontamination dissolves and removes the oxide film and other contaminants formed on the inner surface of the recirculation pipe 22 by reducing them. The reduction contamination solution is produced from oxalic acid supplied to the surge tank 31. To adjust the pH of the reduction decontamination solution, the valve 38 is opened to supply hydrazine from the chemical solution tank 40 into the circulation pipe 35. The circulation pump 32 is driven and the reduction decontamination solution including the hydrazine is supplied into the recirculation pipe 22, where its inner surface is decontaminated by reduction. During reduction decontamination, the valve 61 is opened and the degree of the opening of the valve 56 is adjusted so that part of the reduction decontamination solution is introduced to the cation exchange resin tower 60. Metal cations dissolved from the inner surface of the recirculation pipe 22 into the reduction decontamination solution are removed by being adsorbed by cation exchange resin in the cation exchange resin tower 60.

Upon completion of the reduction decontamination, to decompose the oxalic acid remaining in the decontamination solution, the valve 65 is opened, the degree of the opening of the valve 57 is adjusted, and part of the reduction decontamination solution flowing in the circulation pipe 35 is supplied to the decomposition apparatus 64. At that time, the valve 54 is opened, the injection pump 44 is driven, and the hydrogen peroxide in the chemical solution tank 46 is introduced through the pipe 75 to the decomposition apparatus 64. The oxalic acid and hydrazine included in the reduction decontamination solution are decomposed in the decomposition apparatus 64 by the effects of the hydrogen peroxide and activated carbon catalyst. After the oxalic acid and hydrazine have been decomposed, the valve 55 is closed and the heating by the heater 53 is stopped. The valve 59 is opened at the same time and the decontamination solution is supplied to the cooler 58. After the temperature of the decontamination solution falls to a level (60° C., for example) at which the decontamination solution can be introduced to the mixed bed resin tower 62, the valve 61 is closed and the valve 63 is opened to supply the decontamination solution to the mixed bed resin tower 62. Impurities included in the decontamination solution are removed in the mixed bed resin tower 62.

When temperature rising, dissolution by the oxidizing agent, decomposition of the oxidizing agent, dissolution by reduction, decomposition of the reducing agent (for example, oxalic acid), and purification operation are repeated, for example, two or three times, it becomes possible to dissolve and remove the contamination including an oxide film formed on a metal member (a structure member of the recirculation pipe 22) from which to remove contamination, the oxide film being formed on a surface (wetted surface), which is brought into contact with the reactor water, of the metal member. After the contamination including the oxide film has been removed from the metal member and the oxalic acid and hydrazine included in the reduction decontamination solution have been decomposed, treatment for forming a zinc ferrite film is performed.

After the decontamination from the surface of the metal member being the target of film formation and the decomposition of the reduction decontamination solution have finished, the temperature of the film formation aqueous solution (treatment solution) is adjusted (step S3). After decontamination from the wetted surface of the target (recirculation pipe 22) on which to form a film has been completed and then the film formation apparatus 30 has finished a last purification operation, valves are operated as described below. The valve 76 is opened and valve 52 is closed to start to supply water to the filter 77. To stop the water from being supplied to the mixed bed resin tower 62, the valve 56 is opened and the valve 63 is closed. The valve 55 is opened and the water in the circulation pipe 35 is heated to a prescribed temperature by the heater 53. The valves 47, 57, 33, and 34 are left open, and the valves 36, 59, 61, 65, 38, 41, 42, 49, and 54 are left closed. The reason why the water is passed through the filter 77 is to remove finite solid matter remaining in the water. If the solid matter remains, when a zinc ferrite film is formed on the wetted surface of the target, a ferrite film is also formed on the surface of the solid surface, wasting the chemical. When the above solid matter is removed, the chemical included in the film formation aqueous solution (called the treatment liquid) can be used efficiently. If the water is passed through the filter 77 during decontamination, the dose rate of the filter 77 may become too high due to the solid matter including highly radioactive dissolved radionuclide. Accordingly, after decontamination has been finished, the water is passed through the filter 77. Upon completion of the removal of this solid matter, the valve 52 is opened and the valve 76 is closed.

The above predetermined temperature is preferably about 100° C., but is not limited to 100° C. It suffices to form a ferrite film on the target so that the film structures of crystals and the like in the film are closely formed with low porosity to a degree in which radionuclides included in the cooling water are not included into the ferrite film formed on the target during the operation of the nuclear reactor. Accordingly, the temperature of the treatment liquid is preferably at least 200° C. or lower. A lower limit may be an ordinary temperature (20° C.), but is preferably 60° C. or higher at which a film formation rate falls within a practical range. A lower limit of 100° C. or higher is not preferable because the treatment liquid needs to be pressurized to prevent it from boiling and thus the pressure resistance of tentatively installed facility is demanded to have high pressure resistance, increasing its size.

To form a ferrite film on the target, iron (II) ions need to be adsorbed on the surface of the metal member being the target. Due to dissolved oxygen, however, iron (II) ions in the treatment liquid are oxidized to iron (III) ions according to reaction formula (3). The iron (III) ion has a lower solubility than the iron (II) ion, so the iron (III) ion is deposited as iron hydroxide according to reaction formula (4) and no longer contributes to the formation of the ferrite film. To remove the oxygen dissolved in the treatment liquid, it is preferable to perform inert gas bubbling or vacuum degassing, as described above.

4Fe²⁺+O₂+2H₂O→4Fe³⁺+4OH⁻ (3)

Fe³⁺+3OH⁻→Fe(OH)₃ (4)

After the water circulating in the circulation pipe 35 has reached the prescribed temperature in step S3, a first chemical (aqueous solution), which includes iron (II) ions, is supplied into the circulation pipe 35 (step S4). Specifically, the valve 41 is opened and the injection pump 43 is driven to supply the first chemical, which includes formic acid and iron (II) ions prepared by dissolving iron in the formic acid, into the treatment liquid flowing through the circulation pipe 35 from the chemical solution tank 45. A second chemical (aqueous solution), which includes zinc (II) ions, is then supplied into the circulation pipe 35 (step S5). Specifically, the valve 49 is opened and the injection pump 50 is driven to supply the second chemical, which includes formic acid and zinc (II) ions prepared by dissolving zinc in the formic acid, into the treatment liquid flowing through the circulation pipe 35 from the chemical solution tank 51. Hydrogen peroxide, which is an oxidizing agent (third chemical), is supplied into the circulation pipe 35 (step S6). Specifically, the valve 42 is opened and the injection pump 44 is driven to supply the hydrogen peroxide into the treatment liquid flowing through the circulation pipe 35 from the chemical solution tank 46. The hydrogen peroxide converts iron (II) ions adsorbed on the surface of the metal surface on which to form a film to ferrite. The pH adjustment agent (fourth chemical), which is the last chemical, is supplied into the circulation pipe 35 (step S7). Specifically, the valve 38 is opened and the injection pump 39 is driven to supply hydrazine, which is used as the pH adjustment agent, into the treatment liquid flowing through the circulation pipe 35 from the chemical solution tank 40. As described above, since the first chemical including iron (II) ions, the second chemical including zinc (II) ions, hydrogen peroxide, and hydrazine have been supplied, treatment liquid is prepared, in the circulation pipe 35, from these chemicals and the water in the circulation pipe 35. The treatment liquid passes through the circulation pipe 35 and is supplied to the recirculation pipe 22. A reaction occurs by which a ferrite film including zinc (hereinafter referred to as a zinc ferrite film) is formed on the inner surface of the recirculation pipe 22 with which the treatment liquid is brought into contact. The hydrazine is used to adjust the pH of the treatment liquid within a range of 5.5 to 9.0, at which the reaction starts. A control apparatus (not shown) controls the rotational speed of the injection pump 39 based on a pH measurement of the treatment liquid, which is measured by a pH meter 79 so as to adjust a rate at which the hydrazine is supplied into the recirculation pipe 22. This control enables the pH of the treatment liquid to fall within the above range.

When the treatment liquid including iron (II) ions, zinc (II) ions, hydrogen peroxide, and hydrazine is supplied into the recirculation pipe 22, a zinc ferrite film is formed on the inner surface of the recirculation pipe 22. How the zinc ferrite film is formed on the inner surface of the recirculation pipe 22 will be described in detail with reference to FIG. 7.

If the treatment liquid is acidic, the zinc ferrite film is not formed on the inner surface of the recirculation pipe 22. Accordingly, the pH of the treatment liquid is adjusted within the range of 5.5 to 9.0 by using hydrazine. After the pH of the treatment liquid is adjusted within this range, this treatment liquid is supplied into the recirculation pipe 22 through the circulation pipe 35 and cleanup system pipe 20. OH⁻(O²⁻H⁺) group is adsorbed on the inner surface of the recirculation pipe 22 from which chemical decontamination has been carried out (see (A) in FIG. 7.) The iron (II) ion included in the treatment liquid is substituted for H⁺ of the OH⁻ group adsorbed on the inner surface of the recirculation pipe 22, and combined with O²⁻. The resulting compound is adsorbed on the inner surface of the recirculation pipe 22 (see (B) in FIG. 7). A layer including oxygen ions and iron (II) ions is formed on the inner surface of the recirculation pipe 22. Part of the iron (II) ions adsorbed on the inner surface of the recirculation pipe 22 then undergoes an oxidation reaction caused by an effect of the hydrogen peroxide and changes to iron (III) ions. The zinc (II) ion included in the treatment liquid is substituted for another iron (II) ion adsorbed on the inner surface and the zinc (II) ion combined with O²⁻ is adsorbed on the inner surface of the recirculation pipe 22 (see (C) in FIG. 7). A Zn ferrite film 80 in which O²⁻, iron (III) ions, and zinc (II) ions are combined is formed on the inner surface of the recirculation pipe 22. By hydrolysis, an OH⁻ group is adsorbed to the ion (III) ion and zinc (II) ion to which another OH⁻ group is adsorbed. Since the treatment liquid is present in the recirculation pipe 22, reactions shown in (A) to (D) in FIG. 7 are repeated, causing the Zn ferrite film 80 to grow. A Zn ferrite film 80 is formed on the inner surface of the recirculation pipe 22 in this way.

Steps S4, S5, S6, and S7 are preferably carried out in succession. That is, when the first chemical including iron (II) ions reaches the second connection point in the circulation pipe 35, the second chemical including zinc (II) ions preferably starts to be supplied into the circulation pipe 35; when the treatment liquid including the iron (II) ions and zinc (II) ions reaches the third connection point, hydrogen peroxide preferably starts to be supplied into the circulation pipe 35; when the treatment liquid to which the hydrogen peroxide has been also added reaches the fourth connection point, hydrazine preferably starts to be supplied into the circulation pipe 35. If only the first chemical including iron (II) ions is supplied first and the treatment liquid included only the first chemical is circulated in the system, an oxidization reaction is highly likely to occur due to dissolved oxygen remaining in the system. The first chemical is wasted by an unnecessary reaction and the intended reaction is impeded.

When hydrogen peroxide is supplied to the treatment liquid including iron (II) ions and zinc (II) ions, an oxidation reaction of the iron (II) ion included in the treatment liquid starts. When a ratio of the concentration of an oxidizing agent (hydrogen peroxide, for example) included in the third chemical to the concentration of the iron (II) ions included in the first chemical is reduced to one-fourth (0.25) or less, a ratio between iron (II) ions and iron (III) ions present in the treatment liquid is suitable to the film formation reaction. In this state, however, the treatment liquid is acidic, and thus a ferrite film cannot be formed. To form a ferrite film, a pH adjustment agent, such as hydrazine, is added to adjust the pH of the film formation aqueous solution within the range of 5.5 to 9.0. This adjustment triggers a reaction to produce a Zn ferrite film. To prevent an unnecessary Zn film from being formed on the inner surface of the circulation pipe 35, the pH adjustment agent should be supplied at a point near the part on which to form the Zn ferrite film in the primary containment vessel 11.

The first chemical including iron (II) ions, the second chemical including zinc (II) ions, hydrogen peroxide (third chemical), and hydrazine (fourth chemical) are preferably added into the circulation pipe 35, that is, the treatment liquid in that order. The second chemical may be added before the first chemical is added. The third chemical is preferably added after the first and second chemicals have been added. This is because hydrogen peroxide, which is the third chemical, is easily decomposed on a metal surface at high temperature. If the hydrogen peroxide is added first, part of the hydrogen peroxide is wasted. If the fourth chemical is added before the third chemical is added, a Zn ferrite film is formed, but the diameters of particles constituting the Zn ferrite film are enlarged. To use the chemicals efficiently and obtain a closely formed Zn ferrite film with low porosity on the inner surface of the recirculation pipe 22, the first chemical, the second chemical, the third chemical, and the fourth chemical should be added in that order.

Whether a Zn ferrite film has been formed is judged (step S8). If an insufficient Zn ferrite film is formed, processing from step S4 to step S8 is repeated. If a sufficient Zn film is formed on the inner surface of the recirculation pipe 22, that is, a Zn ferrite film with a predetermined thickness is formed, waste water treatment in step S9 is performed.

In the waste water treatment (step S9), hydrazine and formic acid are decomposed, which are still included in the treatment liquid that has been used to form the Zn ferrite film on the inner surface of the recirculation pipe 22. This treatment liquid will be referred to below as the waster water. The waste water is decomposed in the film formation apparatus 30. While the waste water is being treated, the waste water is supplied from an end of the circulation pipe 35 to an end of the recirculation pipe 22, passing through the recirculation pipe 22, and returned to the other end of the circulation pipe 35 by driving the circulation pump 32. The waste water returned to the circulation pipe 35 through the open/close valve 47 is passed through the heater 53 and the valves 52, 55, 56, and 57, and returned to the surge tank 31 by the circulation pump 48. The valves 76, 59, 61, 63, 36, 41, 42, 49, and 38 are left closed.

The hydrazine and formic acid included in the waste water are decomposed by using the decomposition apparatus 64 as in oxalic acid decomposition carried out after the chemical decontamination. Each degree of openings of the valves 57 and 65 are adjusted and part of the waste water is supplied to the decomposition apparatus 64. The valve 54 is opened and hydrogen peroxide is supplied from the chemical solution tank 46 through the pipe 75 to the decomposition apparatus 64. In the decomposition apparatus 64, the hydrazine and formic acid are decomposed by the effects of the hydrogen peroxide and activated carbon catalyst. The formic acid is decomposed into carbon dioxide and water as shown in chemical formula (5), and the hydrazine is decomposed into nitrogen and water as shown in chemical formula (6).

HCOOH+H₂O₂→CO₂+2H₂O⁻ (5)

N₂H₄+2H₂O₂→N₂+4H₂O⁻ (6)

Although the hydrazine and formic acid can also be treated in the cation exchange resin tower 60, more waste materials of ion-exchange resins are produced. The hydrazine and formic acid are preferably decomposed in the decomposition apparatus 64. An ultraviolet ray irradiation apparatus, which can also decompose hydrazine, formic acid, and oxalic acid under the presence of an oxidizing agent, can be used instead of the decomposition apparatus 64.

The zinc (II) ion included in the treatment liquid is removed as described below, for example. Before the hydrazine and formic acid included in the treatment liquid are decomposed, hydrogen peroxide, which is an oxidizing agent, is added from the chemical solution tank 46 to the treatment liquid, which includes iron (II) ions and zinc (II) ions. The iron (II) ion and zinc (II) ion are precipitated from the treatment liquid as ferrite particles. The iron (II) ion is precipitated as a magnetite particle and the zinc (II) ion as a zinc ferrite particle. The magnetite particle and zinc ferrite particle are removed by the filter 77 from the treatment liquid.

The zinc (II) ion can also be removed as described below. When the formic acid and hydrazine are decomposed, the treatment liquid may be introduced to the decomposition apparatus 64 through the cation exchange resin tower 60 by opening and closing the relevant valves. The zinc (II) ion can then be removed by the cation exchange resin in the cation exchange resin tower 60 during the decomposition of the formic acid and hydrazine. In this method, however, the hydrazine is also removed by the cation exchange resin in the cation exchange resin tower 60 and thereby the amount of waste resin, which is radioactive solid waste, is increased.

Since the hydrazine and formic acid are decomposed into a gas and water in the decomposition apparatus 64 as described above, it can be avoided that the hydrazine is removed in the cation exchange resin tower 60 and that the formic acid is removed in the mixed bed resin tower 62, so the amount of waste of these ion-exchange resin can be significantly reduced.

The stability of the zinc-bearing ferrite film formed by the method in the present embodiment, which is closely formed on the inner surface of the recirculation pipe 22 with a low porosity (less than 0.03%), is further increased as compared with the ferrite film lacking zinc, which is formed by the method described in Japanese Patent Laid-open No. 2006-38483. Thus, deposition of Co-60 and other radionuclides on the inner surface of the recirculation pipe 22 can be further suppressed (see FIG. 2). When the ferrite film including the zinc is formed on the inner surface of the recirculation pipe 22, corrosion of the base metal of the recirculation pipe 22 can also be further suppressed. To further suppress the radionuclide deposition to the inner surface of the recirculation pipe 22, the dose rate of the recirculation pipe 22 can be further reduced. Accordingly, the radiation dose of a worker who periodically inspects the recirculation pipe 22 or repair it can be further reduced. Since the method in the present embodiment uses a chemical lacking chlorine to form a ferrite film including zinc, soundness of the reactor components is not impaired.

In the present embodiment, the oxidizing agent is used in decomposition of oxalic acid employed in the reduction decontamination, the ferrite film formation, and treatment of the waste water resulting from the treatment agent, and the pH adjustment agent is used in the reduction decontamination, the ferrite film formation, and treatment of the waste water resulting from the treatment liquid. The decomposition apparatus 64 is, further, used in decomposition of oxalic acid employed in the reduction decontamination and treatment of the waste water. Accordingly, an oxidizing agent tank, a pH adjustment agent tank, and the decomposition apparatus 64 can be shared in the chemical decontamination and the ferrite film formation (including waster treatment), simplifying the apparatus structure.

A chemical including iron (II) ions, which is prepared by dissolving iron in carbonic acid, can be used as the first chemical, instead of the first chemical including iron (II) ions, which is prepared by dissolving iron in formic acid. In this case, the chemical solution tank 45 is filled with the chemical including iron (II) ions, which is prepare by dissolving iron in carbonic acid. The chemical including iron (II) ions and carbonic acid is supplied from the chemical solution tank 45 into the circulation pipe 35. Accordingly, the treatment liquid includes carbonic acid. The treatment liquid including carbonic acid can be treated in the film formation apparatus 30 as described above. The carbonic acid is decomposed into carbon dioxide and water.

The first chemical agent used in the first embodiment can be prepared by dissolving iron in a formic acid aqueous solution, by precipitating iron (II) formate from the solution in which iron is dissolved in this way and dissolving the iron (II) formate again, or by dissolving iron in organic acid other than formic acid. As the first chemical agent, a solution including iron (II) ions dissolved from an electrode of metallic iron by electrolysis can also be use. Although hydrogen peroxide is used as the third chemical, an oxidizing agent such as oxygen or ozone can also be used. The fourth chemical agent is not limited to hydrazine; any substance can be used if its pH can be maintained within a range of 5.5 to 9.0 and the substance can be easily decomposed into water or into a gas at an ordinary temperature.

As the second chemical, a chemical including nickel (II) ions can also be used. Specifically, the chemical solution tank 51 is filled with a second chemical including formic acid and nickel (II) ions obtained by dissolving nickel in the formic acid, instead of the chemical including zinc (II) ions. Even when the second chemical including nickel (II) ions is used, the film formation apparatus 30 shown in FIG. 6 is used. Operation is the same as before, except that nickel (II) ions are supplied from the chemical solution tank 51 into the circulation pipe 35. The first chemical including iron (II) ions, which is supplied from the chemical solution tank 45, the second chemical including nickel (II) ions, which is supplied from the chemical solution tank 51, hydrogen peroxide supplied from the chemical solution tank 46, and hydrazine, which is supplied from the chemical solution tank 40, are introduced from the circulation pipe 35 to the recirculation pipe 22, as the treatment liquid. When the treatment liquid is brought into contact with the inner surface of the recirculation pipe 22, a ferrite film including nickel (referred to below as a nickel ferrite film) is formed on the inner surface of the recirculation pipe 22 through a process similar to the zinc ferrite film formation process shown in FIG. 7. The nickel ferrite film formed on the inner surface of the recirculation pipe 22 provides the same effect as the Zn ferrite film 80. The treatment liquid that has been used to form the nickel ferrite film is also treated in the same way as in the first embodiment. A chemical including nickel (II) ions, which is prepared by dissolving nickel in carbonic acid, can be used as the second chemical. Similarly, a chemical including zinc (II) ions, which is prepared by dissolving zinc in carbonic acid, can also be used as the second chemical. The second chemical including nickel (II) ions can also be used in a second embodiment described below.

### Second Embodiment

A method for suppressing deposit of radionuclide onto structure member composing a nuclear power plant of a second embodiment which is another embodiment of the present invention will be described below with reference to FIG. 8, the method being applied to a BWR plant. The film formation apparatus 30, shown in FIG. 8, which is used in the present embodiment has the same structure as the film formation apparatus 30, shown in FIG. 6, which is used in the first embodiment. In FIG. 8, part of the structure of the film formation apparatus 30 is omitted. In the for suppressing deposit of radionuclide in the present embodiment as well, steps S1 to S9 shown in FIG. 1 are carried out as in the first embodiment.

A connection point to which the circulation pipe 35 of the film formation apparatus 30 is connected in the present embodiment differs from connection point to which the circulation pipe 35 of the film formation apparatus 30 is connected in the first embodiment. In second embodiment, an end of the circulation pipe 35 is connected through a valve 81 to a branch pipe 82 connected to the recirculation pipe 22. The other end of the circulation pipe 35 is connected through a valve 83 to a branch pipe 84 connected to the recirculation pipe 22. In the present embodiment as well, the recirculation pipe 22 is a target on which to form a ferrite film. Both ends of the recirculation pipe 22 are blocked by plugs 85 and 86. The connection of the circulation pipe 35 to the recirculation pipe 22 and the blocking of both ends of the recirculation pipe 22 by of the plugs 85 and 86 are carried out in step S1. The pipe 74 into which hydrazine is supplied is connected to the circulation pipe 35 near a place where a ferrite film is formed in the primary containment vessel 11. Upon completion of step S1, steps S2 to S7 are executed, after which the Zn ferrite film 80 has been formed on the inner surface of the recirculation pipe 22 as in the first embodiment. Steps S8 and S9 are then executed.

When the film formation apparatus 30 is connected to the recirculation pipe 22 in the present embodiment, two free liquid surfaces are formed in the recirculation pipe 22. The levels of the treatment liquid in the recirculation pipe 22 needs to be controlled to prevent the treatment liquid from flowing into the RPV 12. To reduce the dose rate at a dry well present outside the RPV 12 in the primary containment vessel 11, however, the level of the treatment liquid is preferably as high as possible. The levels of these free liquid surfaces can be controlled by using the valves 34 and 47 to finely adjust a balance between the amount of treatment liquid discharged from the circulation pump 32 and the amount of treatment liquid discharged from the circulation pump 48. A Zn ferrite film is easily formed near the liquid surface of the treatment liquid. Therefore, when the liquid surface is changed, a Zn ferrite film can be formed efficiently even on the inner surface of a riser pipe, in which the treatment liquid is likely to stay, at the top of the recirculation pipe 22. In the present embodiment, the same effect as in the first embodiment can be obtained.

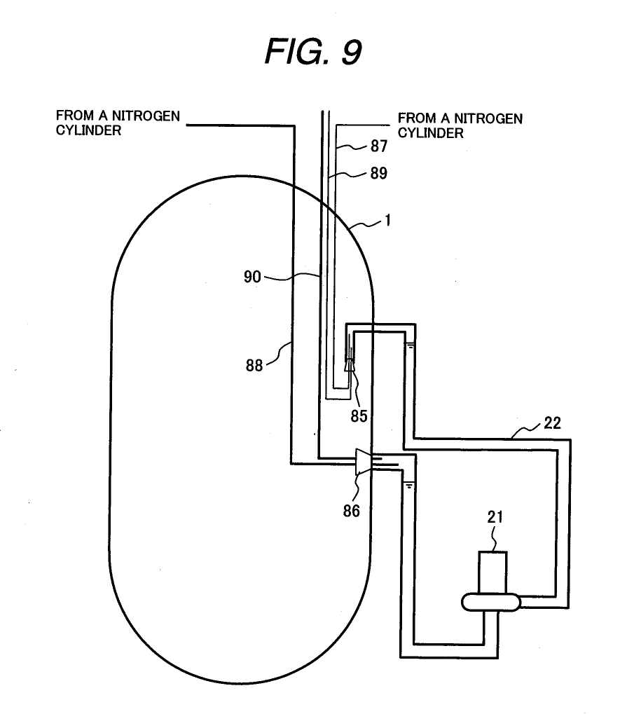

In addition to inert gas bubbling in the chemical solution tank 45 and surge tank 31, the inert gas can be supplied to vapor phases formed above the free liquid surfaces in the recirculation pipe 22. The inert gas (a nitrogen gas, for example) is supplied through an inert gas supply pipe 87 connected to the plug 85 and another inert gas supply pipe 88 connected to the plug 86, as shown in FIG. 9. The inert gas supply pipes 87 and 88 are connected to an inert gas cylinder (not shown) such as a nitrogen gas cylinder. The inert gas is exhausted from the vapor phases through a bent pipe 89 connected to the plug 85 and another bent pipe 90 connected to the plug 86.

### Third Embodiment

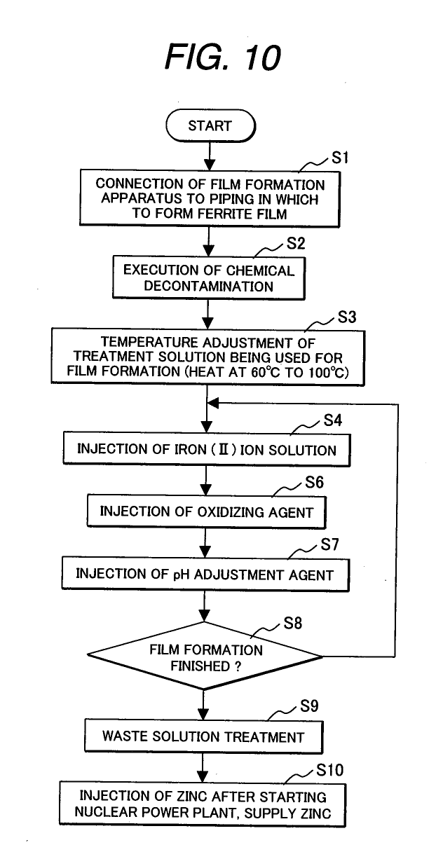

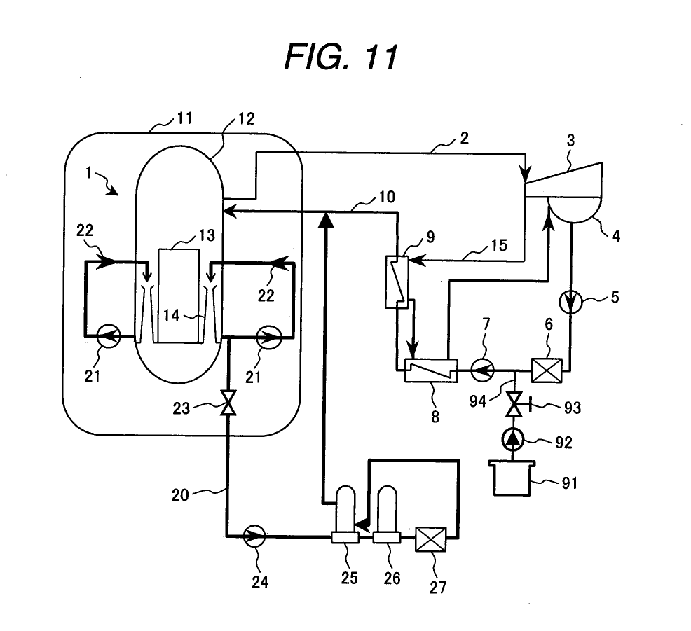

A method for suppressing deposit of radionuclide onto structure member composing a nuclear power plant of a third embodiment which is another embodiment of the present invention will be described below with reference to FIGS. 10 and 11, the method being applied to a BWR plant. A zinc (II) ion injection apparatus is connected to the feed water pipe 10 of the BWR plant, which is a nuclear power plant. The zinc (II) ion injection apparatus has a chemical solution tank 91, an injection pump 92, and an injection pipe 94. The chemical solution tank 91 is connected to the circulation pipe 35 through the injection pipe 94 on which the injection pump 92 and a valve 93 are disposed. The chemical solution tank 91 is filled with a chemical including zinc acetate, which produces zinc (II) ions, such as zinc salt of organic acid. The present embodiment differs from the first embodiment in that the zinc (II) ion injection apparatus is connected to the feed water pipe 10 of the BWR plant, rather than the circulation pipe 35 of the film formation apparatus 30. The structure of the film formation apparatus used in the present embodiment is the same as the structure of the film formation apparatus 30 shown in FIG. 6, except that the zinc (II) ion injection apparatus is eliminated. A solution in which fine particles including zinc carbonate, zinc oxide, or zinc hydroxide are dispersed or a colloidal solution can be used instead of the zinc salt of organic acid. These fine particles and colloid are not zinc (II) ions. When, however, being brought into the RPV 12, they are dissolved by the cooling water at high temperature in the RPV 12, producing zinc (II) ions.

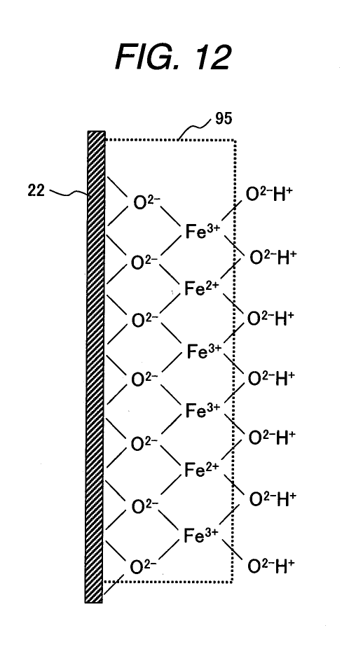

The method for suppressing deposit of radionuclide onto structure member composing a nuclear power plant of the present embodiment by using the above film formation apparatus to form a zinc ferrite film on inner surface of the recirculation pipe 22, will be described in detail with reference to FIG. 10. In the present embodiment, processing in steps S1 to S4 and S6 to S9 is executed as in the first embodiment. The processing in these steps forms a ferrite film 95, shown in FIG. 12, the main component of which is magnetite on the inner surface of the recirculation pipe 22. The ferrite film 95 is referred to be the magnetite film. The magnetite film 95 is formed during a periodic inspection of the BWR plant. After step S9 has been finished, the film formation apparatus is removed from the cleanup system pipe 20 and recirculation pipe 22, as in the first and second embodiments. After the periodic inspection has been finished and the BWR plant is started up, a second chemical including zinc (II) ions is supplied into feed water (step S10). The supply of the second chemical from the zinc (II) ion injection apparatus into the feed water pipe 10 is carried out during, for example, a rated operation the BWR plant. That is, when the valve 93 is opened and the injection pump 92 is driven, the second chemical including zinc (II) ions is supplied from the chemical solution tank 91 to the feed water pipe 10. The zinc (II) ions are introduced to the RPV 12 together with the feed water. Since the recirculation pump 21 has been driven, the zinc (II) ions reach the recirculation pipe 22 together with the cooling water. Fe²⁺ included in the magnetite film 95 formed on the inner surface of the recirculation pipe 22 is replaced with Zn²⁺ included in the cooling water. Accordingly, the Zn ferrite film 80 (see FIG. 7) is formed on the inner surface of the recirculation pipe 22 during the BWR plant operation.

In the present embodiment as well, the effects produced in the first embodiment can be obtained. In the present embodiment, after a plant operation has started, zinc (II) ions can be supplied. Accordingly, for example, even if a dose rate on a pipe is higher than an expected value when the BWR plant operation is finished in an operation cycle, radionuclide deposition to the inner surface of the recirculation pipe 22 can be suppressed. That is, zinc (II) ions can be supplied even in a next operation cycle after an operation cycle and thereby the content of zinc in the magnetite film formed on the inner surface of the recirculation pipe 22 can be increased. Thus, the stability of the zinc ferrite film is improved and corrosion of the recirculation pipe 22 is suppressed. In addition, radionuclide deposition to the inner surface of the recirculation pipe 22 can be suppressed.

The present embodiment can be applied to formation of a Zn ferrite film on the inner surface of the cleanup system pipe 20.

Described below is a difference between when zinc is supplied to the RPV 12 through the feed water pipe 10 in the present embodiment and when zinc is supplied as described in Japanese Patent Laid-open No. Sho 58 (1983)-79196. If the BWR plant is started and zinc is supplied as described in Japanese Patent Laid-open No. Sho 58 (1983)-79196 without any treatment after the recirculation pipe is subject to chemical decontamination, an inner surface of the recirculation pipe, which is exposed due to the chemical decontamination, is brought into contact with the cooling water and then oxidized. The oxide film formed on the inner surface includes an inner-layer film including chromite (FeCr₂O₄), which is positioned near the metal component of the pipe and also includes an outer-layer film including magnetite, which is positioned outside the inner layer. In the oxide film formed as a result of a contact with the cooling water at high temperature, the chromite in the inner layer is membranous and the magnetite in the outer layer is formed by linked particles (see sample B in FIG. 3). Since the radioactive Co-60 ion is easier to enter chromite than to enter magnetite, it passes through clearances in the magnetite and is included in the chromite in the inner layer. When zinc is supplied as described in Japanese Patent Laid-open No. Sho 58 (1983)-79196, however, the cooling water in the RPV 12 includes zinc (II) ions. The zinc (II) ion, which is easier to be included in chromite than the cobalt (II) ion, passes through the magnetite in the outer layer and is included in the chromite in the inner layer. Co-60 deposition to the chromite in the inner layer is thereby suppressed.

In the present embodiment, a magnetite film 95 is closely formed with a low porosity on the inner surface of the recirculation pipe 22 before zinc (II) ions are included in the cooling water in the RPV 12. The metal member of the recirculation pipe 22 is separated from the cooling water by the magnetite film, preventing the metal member from being corroded. Co-60 deposition mainly occurs due to an exchange reaction with iron (II) ions in the formed magnetite film. In the present embodiment, however, the magnetite film 95 is formed on the inner surface of the recirculation pipe 22, and zinc is supplied during a BWR plant operation to produce zinc (II) ions, so the zinc (II) ion present in the cooling water is substituted for Fe²⁺ in the magnetite film 95. Accordingly, a Zn ferrite film 80 with improved stability is formed on the inner surface of the recirculation pipe 22 and Co-60 deposition to the metal member of the recirculation pipe 22 is suppressed.

The chromite film including Zn is always dissolved due to the effect of the dissolved oxidizing agent as the chromite film develops. Therefore, the chromite film including Zn can be maintained only when Zn is continuously supplied. By contrast, the magnetite film is not dissolved by the oxidizing agent. Once zinc is included in the magnetite film, zinc usually does not need to be supplied.

What is claimed is:

1. A method for suppressing deposit of radionuclide onto structure member composing a nuclear power plant, comprising the steps of:
bringing film formation liquid including iron (II) ions and either of zinc (II) ions and nickel (II) ions into contact with a surface of the structure member; and
forming either of a ferrite film including the zinc and a ferrite film including the nickel on the surface of the structure member.

2. A method for suppressing deposit of radionuclide onto structure member composing a nuclear power plant according to claim 1, wherein the ferrite film has a porosity of 0.03 or less.

3. A method for suppressing deposit of radionuclide onto structure member composing a nuclear power plant according to claim 1,
wherein temperature of the film formation liquid which is brought into contract with the surface of the structure member is in a range from 20° C. to 200° C.; and
wherein formation of the ferrite film is performed by adsorbing the iron (II) ions included in the film formation liquid being brought into contract with the surface of the structure member, replacing part of the adsorbed iron (II) ions with either of the zinc (II) ions and nickel (II) ions, and oxidizing another part of the adsorbed iron (II) ions.

4. A method for suppressing deposit of radionuclide onto structure member composing a nuclear power plant according to claim 1,
wherein the film formation liquid further includes an oxidizing agent and temperature of the film formation liquid is in a range from 20° C. to 200° C.

5. A method for suppressing deposit of radionuclide onto structure member composing a nuclear power plant, comprising the steps of:
bringing film formation liquid including a first chemical including iron (II) ions, a second chemical including either of zinc (II) ions and nickel (II) ions, a third chemical for oxidizing the iron (II) ions to iron (III) ions, and a fourth chemical for adjusting pH of the film formation liquid, and being at a temperature of 20° C. to 200° C., into contact with a surface of the structure member; and
forming either of a ferrite film including the zinc and a ferrite film including the nickel on the surface of the structure member.

6. A method for suppressing deposit of radionuclide onto structure member composing a nuclear power plant, comprising the steps of:
bringing film formation liquid including iron (II) ions and being at a temperature of 20° C. to 200° C. into contact with a surface of the structure member;
adsorbing the iron (II) ions on the surface of the structure member;
forming a ferrite film on the surface of the structure member by oxidizing the adsorbed iron (II) ions; and
forming a ferrite film including the zinc by bringing coolant including zinc (II) ions into contact with the ferrite film formed on the surface of the structure member.

7. A method for suppressing deposit of radionuclide onto structure member composing a nuclear power plant according to claim 1,
wherein a pH of the film formation liquid is within a range of 5.5 to 9.0.

8. A method for suppressing deposit of radionuclide onto structure member composing a nuclear power plant according to claim 5,
wherein a pH of the film formation liquid is within a range of 5.5 to 9.0.

9. A method for suppressing deposit of radionuclide onto structure member composing a nuclear power plant according to claim 6,
wherein a pH of the film formation liquid is within a range of 5.5 to 9.0.

10. A method for suppressing deposit of radionuclide onto structure member composing a nuclear power plant according to claim 3,
wherein the film formation liquid, which is brought into contact with the surface of the structure member, is at a temperature within a range from 20° C. to 100° C.

11. A method for suppressing deposit of radionuclide onto structure member composing a nuclear power plant according to claim 5,
wherein the film formation liquid, which is brought into contact with the surface of the structure member, is at a temperature within a range from 20° C. to 100° C.

12. A method for suppressing deposit of radionuclide onto structure member composing a nuclear power plant according to claim 6,
wherein the film formation liquid, which is brought into contact with the surface of the structure member, is at a temperature within a range from 20° C. to 100° C.

13. A method for suppressing deposit of radionuclide onto structure member composing a nuclear power plant according to claim 3,
wherein the film formation liquid, which is brought into contact with the surface of the structure member, is at a temperature within a range from 60° C. to 100° C.

14. A method for suppressing deposit of radionuclide onto structure member composing a nuclear power plant according to claim 5,
wherein the film formation liquid, which is brought into contact with the surface of the structure member, is at a temperature within a range from 60° C. to 100° C.

15. A method for suppressing deposit of radionuclide onto structure member composing a nuclear power plant according to claim 6,
wherein the film formation liquid, which is brought into contact with the surface of the structure member, is at a temperature within a range from 60° C. to 100° C.

16. A method for suppressing deposit of radionuclide onto structure member composing a nuclear power plant according to claim 5,
wherein the second chemical is a formic acid aqueous solution in which either of zinc and nickel is dissolved.

17. A method for suppressing deposit of radionuclide onto structure member composing a nuclear power plant according to claim 6,
wherein the coolant including the zinc (II) ions is prepared by supplying feed water including the zinc (II) ions into the coolant.

18. A method for suppressing deposit of radionuclide onto structure member composing a nuclear power plant according to claim 6,
wherein the coolant including the zinc (II) ions is prepared by supplying feed water, in which a substance containing zinc and producing the zinc (II) ions is included, into the coolant.

19. A method for suppressing deposit of radionuclide onto structure member composing a nuclear power plant according to claim 6,
wherein the ferrite film including the zinc is formed by substituting the zinc (II) ion included in the coolant for the iron (II) ion included in the ferrite film formed on the surface of the structure member before the coolant including the zinc (II) ion is brought into contact with the surface of the structure member.

20. A method for suppressing deposit of radionuclide onto structure member composing a nuclear power plant according to claim 1,
wherein chemical decontamination is carried out on the surface of the structure member before this surface is brought into contact with the film formation liquid.

21. A method for suppressing deposit of radionuclide onto structure member composing a nuclear power plant according to claim 5,
wherein chemical decontamination is carried out on the surface of the structure member before this surface is brought into contact with the film formation liquid.

22. A method for suppressing deposit of radionuclide onto structure member composing a nuclear power plant according to claim 6,
wherein chemical decontamination is carried out on the surface of the structure member before this surface is brought into contact with the film formation liquid.

23. A method for suppressing deposit of radionuclide onto structure member composing a nuclear power plant according to claim 1,
wherein after finish of forming the film, chemical components included in the film formation liquid are decomposed.

24. A method for suppressing deposit of radionuclide onto structure member composing a nuclear power plant according to claim 5,
wherein after finish of forming the film, chemical components included in the film formation liquid are decomposed.

25. A method for suppressing deposit of radionuclide onto structure member composing a nuclear power plant according to claim 6,
wherein after finish of forming the film, chemical components included in the film formation liquid are decomposed.

26. A film formation apparatus, comprising:
a film formation liquid supply pipe for supplying a film formation liquid to a piping system in which to form a film in a nuclear power plant;
a circulation pump, which is installed on the film formation liquid supply pipe, for pressurizing the film formation liquid in the tank;
a first chemical tank for storing a first chemical including iron (II) ions being supplied to the film formation liquid supply pipe;
a second chemical tank for storing a second chemical including either of zinc (II) ions and nickel (II) ions being supplied to the film formation liquid supply pipe;
a third chemical tank for storing a third chemical, which oxidizes the iron (II) ion to an iron (III) ion, being supplied to the film formation liquid supply pipe;
a fourth chemical tank for storing a fourth chemical for adjusting pH of the film formation liquid, the fourth chemical being supplied to the film formation liquid supply pipe;
a film formation liquid return pipe for returning the film formation liquid returned from the piping system to the film formation liquid supply pipe;
a heater for heating the film formation liquid being supplied to the piping system; and
a control apparatus for controlling the heater and adjusting temperature of the film formation liquid within a range of 20° C. to 200° C.

27. A nuclear power plant having a nuclear reactor,
wherein either of a ferrite film including zinc and a ferrite film including nickel is formed on a surface, with which coolant in the nuclear reactor is brought into contact a structure member composing the nuclear power plant.

28. A nuclear power plant according to claim 27,
wherein the surface of the structure member is an inner surface of a pipe in a piping system for introducing the coolant.
